(19) United States
(12) Patent Application Publication
(10) Pub. No.: US 2006/0030260 A1
(43) Pub. Date: Feb. 9, 2006

(54) Variable bandwidth broadband wireless access system and method

(76) Inventors: Teisuke Ito, Fairfax, VA (US); George Allen Martin, Mulberry, FL (US)

Correspondence Address: ROBERTS ABOKHAIR & MARDULA, SUITE 1000, 11800 SUNRISE VALLEY DRIVE, RESTON, VA, 20191, US

(21) Appl. No.: 11/177,228

(22) Filed: Jul. 8, 2005

Related U.S. Application Data
(60) Provisional application No. 60/586,250, filed on Jul. 8, 2004.

(51) Int. Cl. H04H 1/00

(52) U.S. Cl. 455/3.05; 455/83

(57) ABSTRACT

A variable bandwidth broadband wireless access system and method employs flexible headend and CPE configurations that use standard bandwidth allocation devices to split bandwidth between a plurality of modems. Compact PCI cards or ATCA cards at the headend interface with a plurality of PTMC standard-based mezzanine card modems to allocate the headend bandwidth between headend and CPE radio transceivers. PCI cards allocate CPE bandwidth from a plurality of CPE modem cards. The headend can optionally include a digital beamformer between the headend modems and a plurality of headend radio transceivers attached to an antenna array. Bandwidth allocation can be software controlled and new capabilities can be added through the addition of any required modem cards or radios at the headend and CPE locations.

### RELATED APPLICATIONS

This application claims the benefit of prior U.S. Provisional Application No. 60/586,250, filed Jul. 8, 2004, which is hereby incorporated by reference for all purposes.

### BACKGROUND OF THE INVENTION

The present invention is drawn to an extremely flexible approach to allocate and change bandwidth assignments to various networking elements of wireless communication systems, which may include a smart antenna beamforming device to accommodate a large throughput. The apparatus of the present invention is designed in a modular and cost-effective manner to provide both robustness and high Quality of Service (QoS) to Broadband Wireless Access (BWA) Networks.

As illustrated in Prior Art FIG. 1, a traditional BWA network consists of one type of transceiver (T/R), one type of modem, and typically one or two types of line interface devices, e.g. Ethernet or DS3. These systems are limited in application to only one type of communication device, both with respect to the input/output device and modulation scheme, which makes the interface very cumbersome. Furthermore, it becomes quite costly to build a complex network with so many different types of devices.

For example, BWA systems available from Alvarion, such as BreezeMAX, use exclusively Ethernet Local Area Network (LAN) and analog telephone lines for their input/output devices, and Orthogonal Frequency Division Multiplexing (OFDM) for their modulation scheme.

The present invention, as illustrated in FIG. 2, shows that a BWA network in accordance with the present invention that is equipped with the bandwidth allocation device has a complete freedom, in comparison to the traditional BWA, to combine different standards in I/O and modulation equipment. It even enables exchange and re-allocation of bandwidths among the different equipment by a simple software command.

### BRIEF SUMMARY OF THE INVENTION

The present invention provides a method and apparatus for flexibly setting up and controlling the bandwidth allocation at both headend and Customer Premise Equipment (CPE) locations in a BWA network.

It is an aspect of the present invention to provide the capability to merge, separate and switch bit streams to and from various I/O sources and to make this capability available in many telecommunication devices, preferably using a standard carrier card with I/O switching capability.

It is a further aspect of the present invention to provide improved modem control via a user-definable table accessed by either a modem in accordance with the present invention or a standard bandwidth allocation device that controls the bandwidth assignment of the modem. This enables a precise throughput throttling to any level that is within the maximum capacity of the modem. At the headend of a point to multipoint system, this mechanism can move assets from one remote CPE to others simply by changing the table entry.

It is yet another aspect of the present invention to provide a digital beamformer for use in BWA networks. The programmability of the digital beamformer can easily assign and change distribution of maximum throughput among all the remote CPEs in various locations.

### BRIEF DESCRIPTION OF THE DRAWINGS

FIG. 1 illustrates a typical prior art BWA Network;

FIG. 2 illustrates one embodiment of an expandable BWA Network in accordance with the present invention.

FIG. 3 illustrates a basic architecture for practicing the present invention;

FIG. 4 illustrates a more detailed embodiment of the present invention.

### DETAILED DESCRIPTION OF THE INVENTION

The bandwidth allocation device of the present invention guarantees assigned maximum data rate for each user of BWA Networks. This comes in the form of a Peripheral Component Interconnect (PCI) card, a compact PCI card or an Advanced Telecom Compute Architecture (ATCA) card together with application specific add-on cards. Each unit is capable of combining, distributing and redirecting various digital traffic patterns in a software-configured mode. Because of its generic design it can be used both at the headend and remote sites of a wireless point-to-multipoint network.

At each remote site, a PCI version of this card can distribute the incoming digital data stream to any combination of lower rate substreams such as TI or Internet Protocol (IP) traffic based on the requirements. According to the sector structure of each remote site, a different allocation scheme might be desired, including the possibility of having multiple sectors in future headend units. A variety of these software-definable configurations can be accomplished with its bandwidth allocation unit, while always maintaining the QoS. Additionally, the same allocation unit can be used in distributing bandwidth among the tenants of Multi Tenant Units (MTU) or Multi Dwelling Units (MDU) through cables or wirelessly.

At the headend, the compact PCI or ATCA version of these cards easily accommodates higher data rates, as well as hot swappability. In the current design, each card can handle up to OC-3 data rate, and a multiple number of these cards can be used to increase capacity even higher.

The present invention is drawn to the integration of wireless telephony and data services with computers, servers, Private Branch Exchange (PBX) devices, and other computer-related equipment. This new platform includes building blocks and services that converge voice and data technologies and enable the creation of the modular network. It is part of a broader “multi-service networking” concept that combines all types of communication onto a single wireless network that seamlessly supports data, voice, and video with a high quality of service. Additionally, the new wireless systems can be linked to servers that run a variety of essential applications, including PBX services, Voice over IP (VoIP), real-time multimedia transmission (voice and video), IP networks and the Internet.

By adding other vendors software/hardware packages to the Gateway/Server platform with the current device, an additional suite of features can be offered form basic voice, fax, conferencing, and speech technologies, telephone and IP network interfaces, PBX integration products, carrier-class board systems-level products, and more to help satisfy the communications need of the enterprise environments and service provider market segments.

One of the best implementations of the present invention is to provide improvements in the service limitations of the traditional wireless system. The prior art systems are mostly proprietary with embedded control functions and feature logic. That makes it difficult to add new features. In addition, the end devices are limited in functionality to a fixed port type. In contrast, new services are easy to add into the world equipped with the present invention by simply adding new applications to this device's control computer using the CPU and additional card slots. There is no need to put additional support in the wireless network itself for these services—all the network has to do is transport data with good quality of service.

This model put forth in the present invention reverses the thinking of the old model. The old model was “dumb endpoints driven by an intelligent network.” The model presented herein comprises intelligent endpoints communicating over a relatively dumb wireless network. The current initiative can be used to define and build advanced Data & Telecom networks that use a seamless wireless network.

This gateway is a network element that provides conversion between the signals carried on telephone circuits and data packets carried over the Internet or over other packet networks on to a wireless network providing QoS services related to each unique application or Data Type. This gateway essentially replicates the behavior of the PSTN or the Internet. The purpose of this gateway is to interconnect the Internet packet world with the switched circuit world.

This system makes it easy to offer top-quality high-speed Internet access along with Voice applications to multi-tenant-unit and multi-dwelling-unit properties. And unlike alternative access technologies, this will deliver the speed and reliability consumers demand without costly installation and support problems for service providers or building operators.

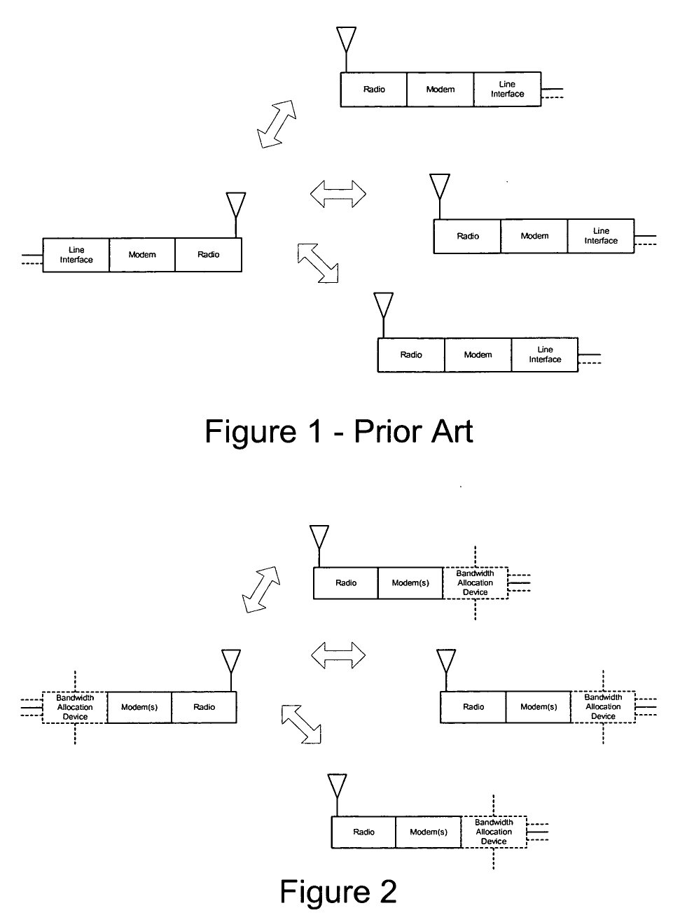

As discussed above, a BWA network constructed in accordance with the present invention, as illustrated in FIG. 2, has advantages over the prior art BWA network shown in FIG. 1 in that a standard bandwidth allocation device used with the present invention has the freedom to combine different standards in I/O and modulation equipment because the radios of the present invention can interface with multiple modems. This arrangement further enables exchange and re-allocation of bandwidths among the different equipment by a simple software command to either the present invention's modem board and/or the commercially available bandwidth allocation device.

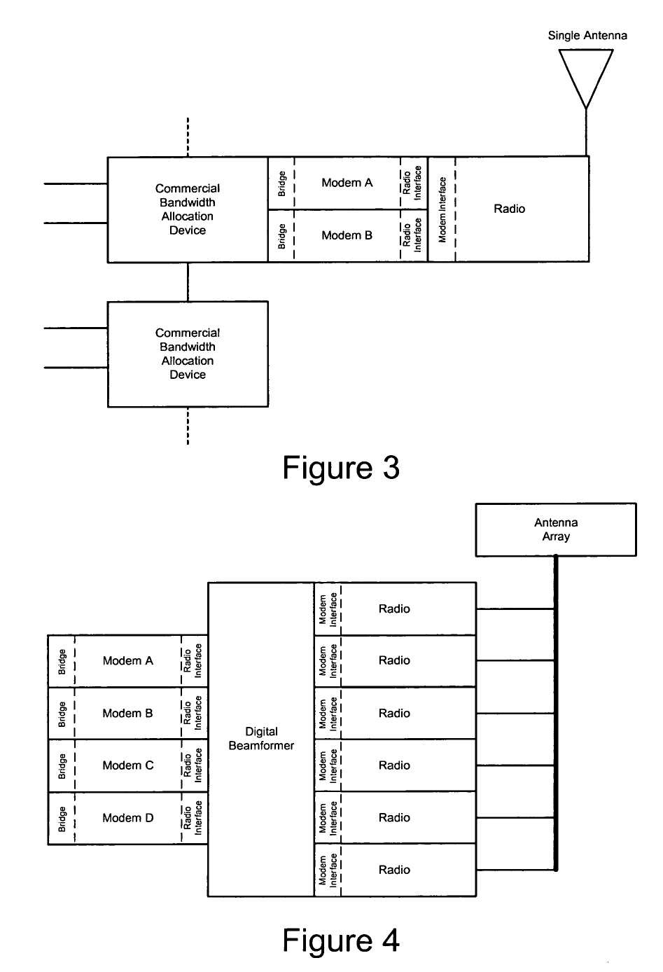

FIG. 3 illustrates a more detailed exemplary embodiment of the architecture of the present invention, including the required building blocks to achieve a flexible BWA. In this embodiment, a single antenna and radio are attached to a single modem interface, which in turn is attached to a plurality of modems via corresponding radio interfaces on each modem. Each modem is attached to a standard bandwidth allocation device via a suitable bridge device.

The radios of the present invention can be any radio suitable for use with WBA networks. In a preferred embodiment, the present invention operates in the 5.7 to 5.8 GHz band using a model no. TSI SD-1116-R01 Digital Interface Transceiver sourced by the present inventors from Trackcom Systems International Inc. of Montreal, Canada.

There are a variety of bandwidth allocation devices commercially available that use different approaches to accomplish the objective desired by the present invention. The type illustrated for the present invention, although not a limitation, is based on industry standards for telephony interfaces: PCI Telecom Mezzanine/Carrier Card (PTMC) Specification from PICMG (PCI Industrial Computer Manufacturers Group) and Enterprise Computer Telephony Forum's (ECTF) H.100/H.110 Hardware Compatibility Specification, and other related specifications. In use, the one embodiment of the present invention uses a model no. HW400c/M-LC card available from SBE Inc. of San Ramon, Calif.

The modem interface device used by the radio can be designed with a number of different approaches. In a preferred embodiment, the present invention provides the required modem interface via digitized low Intermediate Frequency (IF) waveforms.

The radio interface device used by each modem can be designed with a number of different approaches. In a preferred embodiment, the present invention provides each required radio interface via digitized low Intermediate Frequency (IF) waveforms.

The bridge device to interface each modem with the bandwidth allocation device can be any combination of (Computer Telephony) CT lines, Reduced Media Independent Interface (RMII) and Ethernet packets through the PCI bus, which are specified in the PT2MC of PICMG 2.16 Standard. In a preferred embodiment, the present invention provides the required bridge by selecting one or more of these data formats inside a Field Programmable Gate Array (FPGA).

Such an apparatus can be assembled to build a communication network with modularity, expandability and reliability. It enables a multiple number of Input/Output (I/O) devices to be added to the network as indicated in FIG. 3. It also switches the data traffic patterns based on the software-defined configuration in the bandwidth allocation device and/or modem.

The modems used in the present invention can be any modem suitable for use with BWA networks, but preferably come in the form of PTMC standard based mezzanine cards with well-defined mechanical and electrical interfaces, although this is not meant as a limitation. Such card-based modems allow insertion of different type of modems into the network without changing other parts of the system.

The bridge in the modem card transforms the incoming data, whether it is a constant bit stream as carried through the CT lines or IP packets through the local PCI bus, into required data frames for the particular modem. This is done with minimum latency and the bit rate is preserved all through the network, which is critical in voice and video applications. The reverse transformation is simultaneously performed to achieve the frequency division duplex (FDD) mode of operation.

The interface from modems to radios (transceivers) is also done digitally, eliminating the normal difficulties associated with analog circuits and devices. The digital interface simplifies multiplexing and demultiplexing of channels with precision in timing. It also makes it easy to add a longer distance connection between modems and radios with Low Voltage Differential Signaling (LVDS) or fiber optic cables.

At the other end of the modem-radio connection, the radios also provide the required digital interface. The antennas used in this configuration are normal commercial antennas satisfying particular radio frequency (RF) propagation requirements.

Another advantage of the modem-radio digital interface of the present invention is the easy insertion of a digital beamforming subsystem between the two devices in the headend of a point to multipoint system, as illustrated in FIG. 4. A larger number of modems are preferably connected digitally to the beamforming device. This enables a multi-fold increase in the network capacity without increasing the number of RF channels. The output of the beamformer is, likewise, preferably connected to a multiple number of radios, which in turn are connected to different elements of an antenna array. Such an antenna array can be any suitable array, as is known in the art. The present invention can advantageously use microstrip patch antennas for ease of precise mechanical alignment with low weight.

The antenna array is software controlled and, with the help of the digital beamformer, is capable of generating beams in specified directions with specified width to accommodate different capacity requirements in different azimuthal regions of a point-to-multiple point wireless system. The flexibility of the software configuration also enables re-distribution and re-allocation of throughputs to different Customer Premise Equipment (CPEs).

In a preferred embodiment, the digital beamformer is implemented by use of commercially available Application Specific Integrated Circuits (ASIC), Field Programmable Gate Arrays (FPGA), and a variety of beamforming algorithms.

Although disclosed with reference to a few preferred embodiments, the present invention is not meant to be so limited. Those of skill in the art will recognize that various modifications can be made without departing from the scope of the present invention, which is limited only by the attached claims.

What is claimed is:

1. A variable bandwidth Broadband Wireless Access system, comprising:
a headend bandwidth allocation device for connection to a headend network connection;
a plurality of headend modems connected to the first bandwidth allocation device;
at least one headend radio transceiver;
at least one customer premises equipment (CPE) radio transceiver for communicating wirelessly with said headend transceiver;
a plurality of CPE modems connected to said at least one CPE radio transceiver; and
a CPE bandwidth allocation device for each CPE radio transceiver.

2. The system of claim 1, wherein:
said headend bandwidth allocation device is selected from the group selected from PCI, compact PCI, and ATCA cards; and
each CPE bandwidth allocation device is a PCI card.

3. The system of claim 1, further comprising:
said headend and CPE bandwidth allocation devices being PCI Telecom Mezzanine/Carrier Card (PTMC) Specification cards from PCI Industrial Computer Manufacturers Group (PICMG) and Enterprise Computer Telephony Forum's (ECTF) H.100/H.110 Hardware Compatibility Specification;
said headend modem and each CPE modem being PTMC standard-based mezzanine cards, wherein each of said cards further include a suitable bridge to communicate with the attached bandwidth allocation device and a suitable radio interface for communicating with the attached radio transceiver; and
said headend radio transceiver and each CPE radio transceiver including a suitable modem interface.

4. The system of claim 1, further comprising:
each headend modem including a suitable bridge to the headend bandwidth allocation device and a suitable radio transceiver interface;
a plurality of headend radio transceivers attached to an antenna array, each headend radio transceiver including a suitable modem interface; and
a digital beamformer connected between said plurality of headend modems and said plurality of headend radio transceivers.

5. A variable bandwidth Broadband Wireless Access method, comprising:
allocating headend bandwidth to a plurality of modems;
interfacing said plurality of modems to at least one headend radio transceiver;
communicating data wirelessly to at least one CPE radio transceiver;
interfacing said at least one CPE radio transceiver to a plurality of CPE modems; and
allocating data from said CPE modems.

6. The method of claim 5, further comprising
allocating said headend bandwidth using a device is selected from the group selected from PCI, compact PCI, and ATCA cards; and
allocating CPE bandwidth with at least one PCI card.

7. The method of claim 5 further comprising:
performing said bandwidth allocation with PCI Telecom Mezzanine/Carrier Card (PTMC) Specification cards from PCI Industrial Computer Manufacturers Group (PICMG) and Enterprise Computer Telephony Forum's (ECTF) H.100/H.110 Hardware Compatibility Specification; and
using PTMC standard-based mezzanine cards for said modems.

8. The method of claim 5, further comprising:
providing each headend modem with a suitable bridge to the headend bandwidth allocation device and a suitable radio transceiver interface;
attaching a plurality of headend radio transceivers to an antenna array, wherein each headend radio transceiver is provided with a suitable modem interface; and
connecting a digital beamformer between said plurality of headend modems and said plurality of headend radio transceivers.

9. A digital beamformer system for Broadband Wireless Access networks, comprising:
a plurality of modems;
a plurality of digital beamformer cards for uplink and downlink processing;
a plurality of radios; and
an antenna array with multiple elements;
wherein said modems interface with said digital beamformer cards that interfaces with said radios that interface with the antenna array.

10. The system of claim 9, wherein said antenna array further comprises a microstrip patch antenna for ease of precise mechanical alignment and lightweight.

11. A digital beamformer method for Broadband Wireless Access networks, comprising
interfacing a plurality of modems with a plurality of digital beamformer cards;
interfacing said digital beamformer cards with a plurality of radios; and
interfacing said plurality of radios with an antenna array;
wherein software algorithms control the digital beamformer cards.

12. The method of claim 11, further comprising using Application Specific Integrated Circuits (ASIC), Field Programmable Gate Arrays (FPGA) and a plurality of beamforming algorithm means to control and configure the input and output of the antenna array.

13. The system of claim 1, further comprising a plurality of CPE radio transceivers, each having one or more modems attached thereto.

14. The method of claim 5, further comprising transmitting data to a plurality of CPE radio transceivers, wherein each CPE transceiver interfaces with one or more CPE modems.
